(19) United States
(12) Patent Application Publication
(10) Pub. No.: US 2023/0409368 A1
(43) Pub. Date: Dec. 21, 2023

(54) VIRTUAL MACHINE AUTOSCALING WITH OVERCLOCKING

(71) Applicant: Microsoft Technology Licensing, LLC, Redmond, WA (US)

(72) Inventor: Tariq SIDDIQUI, Kirkland, WA (US)

(73) Assignee: Microsoft Technology Licensing, LLC, Redmond, WA (US)

(21) Appl. No.: 17/843,745

(22) Filed: Jun. 17, 2022

(51) Int. Cl. G06F 9/455; G06F 1/08

(52) U.S. Cl. CPC G06F 9/45558; G06F 1/08; G06F 2009/4557; G06F 2009/45575

(57) ABSTRACT

A system and method for autoscaling virtual machine nodes of a node group includes monitoring one or more metrics of virtual machine nodes to detect an autoscaling condition requiring that one or more virtual machine nodes be provisioned or shut down for the node group. An autoscaling process associated with the autoscaling condition is the performed. When the autoscaling process includes provisioning one or more additional nodes for the node group, an overclocking process I is performed to increase a clock rate of a processor of at least one computing device hosting the virtual machine nodes of the node group from a default clock rate to an overclocking rate, the overclocking process being performed while the one or more additional nodes are being provisioned.

### BACKGROUND

A cloud computing system refers to a collection of computing devices capable of providing remote services and resources. For example, modern cloud computing infrastructures often include a collection of physical server devices organized in a hierarchical structure including computing zones, virtual local area networks (VLANs), racks, fault domains, etc. Cloud computing typically utilizes virtual machines hosted on one or more servers to accommodate user demand for computation, communications, or other types of computing services. For example, servers can host one or more virtual machines to provide user logon, email hosting, web searching, website hosting, system updates, application development, or other types of computing services. As such, the users can share computing, memory, network, storage, or other suitable types of resources of hosting servers.

Cloud computing systems can receive varying levels of traffic for various reasons, such as holidays, weekends, events, times of day (e.g., before, during and/or after business or school hours), and the like. Cloud computing systems often utilize autoscaling to scale resources to account for variations in traffic and/or load on the system. For example, an autoscaler can monitor the load on the system and provision additional virtual machines to handle increased loads on the system. The autoscaler can also reduce the amount of provisioned virtual machines when the load on the system decreases.

One drawback of the foregoing technique is that provisioning additional virtual machines to accommodate increases in traffic may take a considerable amount of time (e.g., twenty minutes or even longer) to fully initialize and become available to users. Meanwhile, users may experience service slowdowns, dropped/rejected requests, or even outages while the additional resources are initializing. One method that has been used to address the problem of service delays and dropped/rejected requests as resources are being scaled is predictive autoscaling. Predictive autoscaling predicts future times when increases in traffic are likely to occur and scales resources in advance of these predicted times. While this strategy is useful, predictions are not always accurate and there may still be times when increased traffic is unexpected and therefore unlikely to be predicted. In these instances, service delays and dropped/rejected requests may still occur while resources are being provisioned to accommodate the unexpected increases.

Hence, what is needed are systems and methods of scaling resources of a cloud computing system to address increased loads and traffic that does not result slowdowns and delays for users of the system while additional resources are being provisioned.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 shows an example of a computing device for implementing virtual machine nodes for a cloud computing system, such as the cloud computing system of FIG. 1.

FIG. 3 shows an example of an autoscaler for autoscaling virtual machine nodes of a cloud computing system, such as the cloud computing system of FIG. 1, that includes an overclocking component on accordance with this disclosure.

FIG. 4 shows a flowchart of a method of autoscaling virtual machine nodes of a cloud computing system that utilizes overclocking.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### SUMMARY

In one general aspect, the instant disclosure presents a computing device including a processor and a memory in communication with the processor having executable instructions that, when executed by the processor, cause the computing device to perform multiple functions. The multiple functions include the steps of monitoring one or more metrics of virtual machine nodes of a node group to detect an autoscaling condition requiring that one or more virtual machine nodes be provisioned or shut down for the node group; performing an autoscaling process associated with the autoscaling condition; and when the autoscaling process includes provisioning one or more additional nodes for the node group, performing an overclocking process to increase a clock rate of a processor of at least one computing device hosting the virtual machine nodes of the node group from a default clock rate to an overclocking rate, the overclocking process being performed while the one or more additional nodes are being provisioned.

In yet another general aspect, the instant disclosure presents a method of autoscaling virtual machine nodes of a cloud computing system. The method includes monitoring one or more metrics of virtual machine nodes of a node group to detect an autoscaling condition requiring that one or more virtual machine nodes be provisioned or shut down for the node group; performing the autoscaling process associated with the autoscaling condition; and when an autoscaling process includes provisioning one or more additional nodes for the node group, performing an overclocking process to increase a clock rate of a processor of at least one computing device hosting the virtual machine nodes of the node group from a default clock rate to an overclocking rate, the overclocking process being performed while the one or more additional nodes are being provisioned.

In a further general aspect, the instant application describes a non-transitory computer readable medium on which are stored instructions that when executed cause a programmable device to perform multiple functions. The functions include monitoring one or more metrics of virtual machine nodes of a node group to detect an autoscaling condition requiring that one or more virtual machine nodes be provisioned or shut down for the node group; performing an autoscaling process associated with the autoscaling condition; and when the autoscaling process includes provisioning one or more additional nodes for the node group, performing an overclocking process to increase a clock rate of a processor of at least one computing device hosting the virtual machine nodes of the node group from a default clock rate to an overclocking rate, the overclocking process being performed while the one or more additional nodes are being provisioned.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Cloud computing systems typically utilize virtual machine nodes hosted on one or more servers to accommodate user demand for computation, communications, or other types of computing services. For example, servers can host one or more virtual machine nodes to provide user logon, email hosting, web searching, website hosting, system updates, application development, or other types of computing services. As such, the users can share computing, memory, network, storage, or other suitable types of resources of hosting servers. Cloud computing system typically implement some type of autoscaling system to scale virtual machine nodes to accommodate variations in the load on the system. An autoscaling system is typically configured to monitor the load on the system and provision additional virtual machines when the load on the system increases and shut down virtual machine nodes when the load on the system decreases.

One drawback of the previously known autoscaling systems is that provisioning additional virtual machines to accommodate increases in traffic may take a considerable period of time (e.g., twenty minutes or even longer) to fully initialize and become available to users. Meantime, users may experience service slowdowns, dropped/rejected requests, or even outages while the additional resources are initializing. One method that has been used to address the problem of service delays and dropped/rejected requests as resources are being scaled is predictive autoscaling. Predictive autoscaling forecasts future times when increases in traffic are likely to occur and scales resources in advance of these forecasted increases. While this strategy is useful, predictions are not always accurate, and there may still be times when increased traffic is not expected. In these instances, service delays and dropped/rejected requests may still occur while resources are being provisioned.

To address these technical problems and more, in an example, this description provides technical solutions for reducing or preventing system delays and dropped/rejected requests while virtual machine nodes are being provisioned to accommodate increases in load on a cloud computing system. These solutions involve overclocking, i.e., increasing the clock rate, of the processors of the computing devices hosting the virtual machine nodes. The clock rate is increased from a default clock rate for the processors to an overclocking rate that enables the virtual machine nodes hosted on the processor to perform more operations per second which in turn enables the virtual machine nodes to the better handle increased loads while additional virtual machine nodes are being provisioned.

In operation, one or more metrics of the virtual machines nodes of a cloud computing system are monitored to detect conditions requiring additional virtual machine nodes to be provisioned. Examples of metrics that may be monitored include processor utilization of the nodes, number of connections to the nodes, and the like. When a condition requiring provisioning of additional virtual machine nodes is detected, an autoscaling process is initiated to provision the requisite number of nodes for the system. In conjunction with the autoscaling process, one or more physical processors hosting the virtual machine nodes is overclocked to enable the virtual machine nodes to process requests at a faster rate to better handle the increased load on the system while the additional virtual machine nodes are being provisioned. Once the additional virtual machine nodes have been completely initialized and are performing operations, the overclocking of the one or more processors hosting the virtual machine nodes may be stopped, e.g., by returning the one or more processors to their default clock rates.

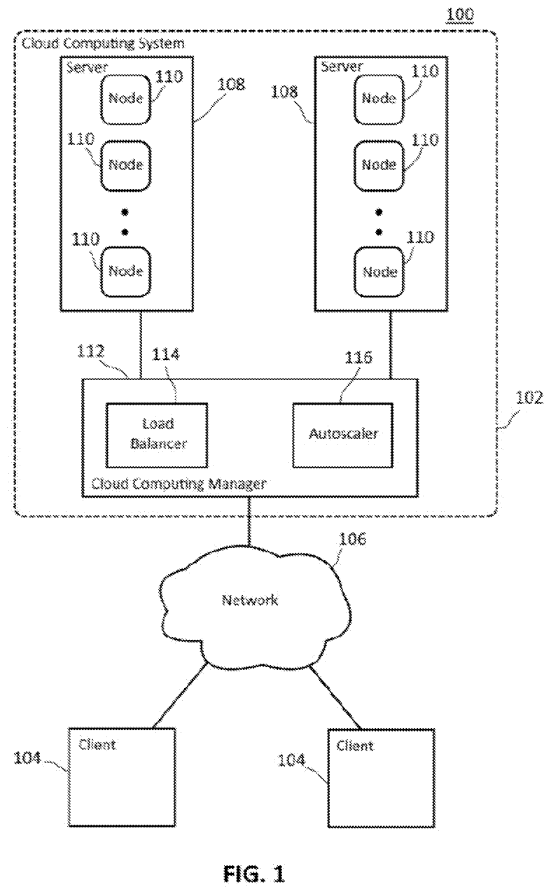

FIG. 1 shows an example system 100, upon which aspects of this disclosure may be implemented. The system 100 includes on a cloud computing system 102, clients 104 and a network 106. Cloud computing system 102 includes one or more servers 108 configured to provide one or more services or applications to clients, such as clients 104, 106. Servers 108 may be any type of server including database servers, file servers, mail servers, print servers, web servers, game servers, and application servers. Servers may be organized in farms, clusters, racks, containers, data centers, geographically disperse facilities, and the like, and may communicate with each other via a variety of types of networks.

Two servers 108 are shown as part of the cloud computing system 102 of FIG. 1 although in implementations any suitable number of servers may be utilized. Each server 108 includes one or more virtual machine nodes 110 that provide computing resources for the servers 108 for processing requests from clients, executing applications and implementing the functionality of the servers 108. In embodiments, servers 108 may include any suitable number of nodes 110.

Cloud computing system 102 may include a cloud computing manager 112 for managing resources of the cloud computing system 102. As such, the cloud computing manager 112 may be used for deploying, configuring and/or managing servers 108 and other resources of the system 100. The cloud computing manager 112 may be implemented in one or more computing devices which may be part of or separate from the servers. In embodiments, cloud computing manager 112 may be configured to implement a load balancer 114 for receiving requests from clients and directing requests to the appropriate server 108 and/or node 110 of a server 108. The load balancer 114 may utilize parameters such as load, number of connections, and overall performance to determine which server 108 and/or node 110 receives a client request.

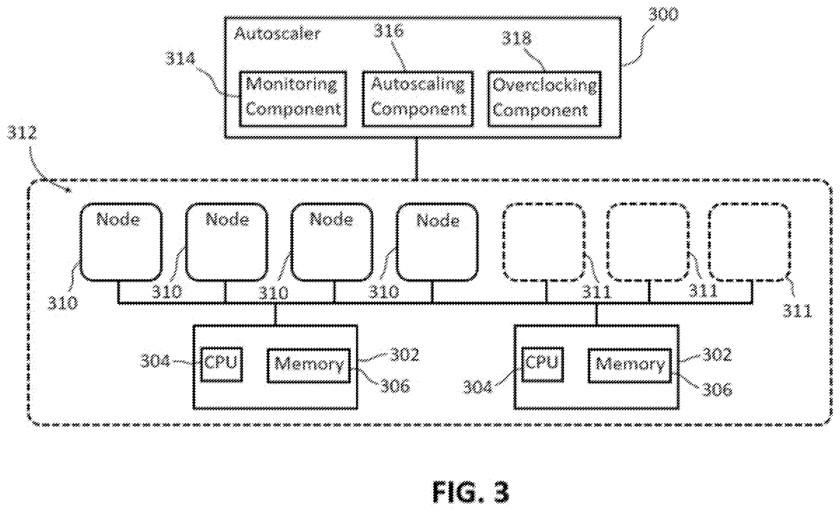

Cloud computing system 102 may also include an autoscaler 116 for adjusting the number of available computational resources, e.g., virtual machine nodes 110, in the cloud computing system 102 automatically based on the load or demand on the system. Autoscaler 116 may be configured to monitor one or more metrics indicative of the load on the cloud computing system 102, such as processor usage, memory usage, number of connections, and the like, and then scale the resources accordingly. When the load or traffic to the system is high, autoscaler 116 may provision additional virtual machine nodes 110 so that more requests may be handled in a shorter amount of time. At times of reduced loads on the system, autoscaler 116 may be configured shut down virtual machine nodes 110 which are being underutilized. The implementation of the autoscaler is discussed in greater detail in regard to FIG. 3.

Clients 104 enable users to request access to services and/or applications offered by the cloud computing system 102. Clients 104 may comprise any suitable type of computing device that enables a user to interact with various applications. Examples of suitable computing devices include but are not limited to personal computers, desktop computers, laptop computers, mobile telephones, smart phones, tablets, phablets, smart watches, wearable computers, gaming devices/computers, televisions, and the like. Clients 104 and cloud computing system 102 communicate via network 106. Network 106 may include one or more wired/wireless communication links and/or communication networks, such as a PAN (personal area network), a LAN (local area network), a WAN (wide area network), or a combination of networks, such as the Internet.

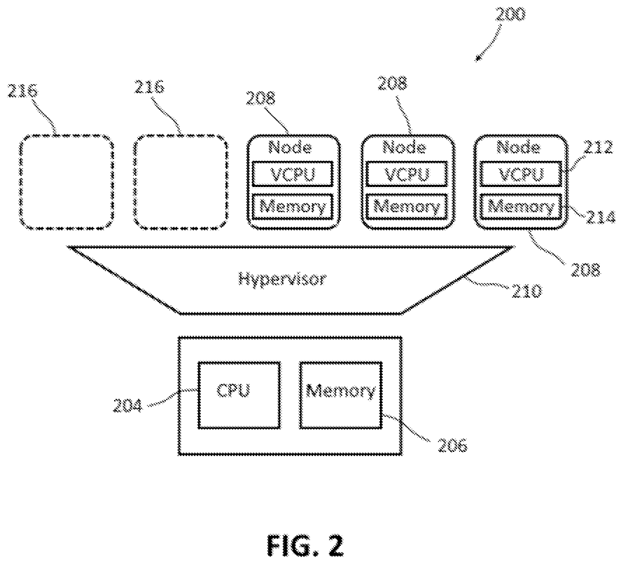

Each server 108 may include one or more physical computing devices for hosting the virtual machine nodes 110 of the server 108. FIG. 2 shows an example of such a computing device. Computing device 200 of FIG. 2 may be any of a variety of different types of computing device. For example, computing device 200 may be a desktop computer, a server computer, a laptop, and the like. Computing device 200 includes physical resources, such as a central processing unit (CPU) 204 and memory 206. Computing device 200 may include other components not shown, such as network interface devices, disk storage, input/output devices, and the like. The CPU 204 may be any type or brand of CPU. The memory 206 may include volatile and/or nonvolatile media (e.g., ROM; RAM, magnetic disk storage media; optical storage media; flash memory devices, and/or other suitable storage media) and/or other types of computer-readable storage media configured to store data received from, as well as instructions for, the CPU 204. Though computing device 200 is shown as having only one CPU 204 and one memory 206, a computing device may include any suitable number of processors and/or memories.

Computing device 200 is a host device, and, as such, is configured to host one or more virtual machine nodes 208. To this end, computing device 200 includes a hypervisor 210 configured to generate, monitor, terminate, and/or otherwise manage virtual machines nodes 208. Hypervisor 210 is software, firmware and/or hardware that emulates virtual resources for the virtual machines nodes 208 using the physical resources 204, 206 of the computing device 200. More specifically, hypervisors 210 allocate processor time, memory, and disk storage space for each virtual machine node 208. The hypervisor 210 also provides isolation between the virtual machines nodes 208 such that each virtual machine node 208 can include its own operation system and run its own programs.

Virtual machine nodes 208 are software implementations of physical computing devices that can each run programs analogous to physical computing devices. Each virtual machine node 208 may include virtual resources, such as virtual processor (VCPU) 212 and virtual memory 214 and may be configured to implement a guest operating system. The VCPU 212 is implemented as software with associated state information that provide a representation of a physical processor with a specific architecture. Different virtual machine nodes 208 may be configured to emulate different types of processors. For example, one virtual machine node may have a virtual processor having characteristics of an Intel x86 processor, whereas another virtual machine node may have the characteristics of a PowerPC processor. Guest operating system may be any operating system such as, for example, operating systems from Microsoft®, Apple®, Unix, Linux, and the like. Guest operating system may include user/kernel modes of operation and may have kernels that can include schedulers, memory managers, etc. Each guest operating system may have associated file systems implemented in virtual memory and may schedule threads for executing applications on the virtual processors. Applications may include applications for processing client requests and/or implementing functionality of the server.

The hypervisor 210 enables multiple virtual machine nodes 208 to be implemented on computing device 200 by allocating portions of the physical resources 204, 206 of the computing devices 200, such as processing time, memory, and disk storage space, to each virtual machine node 208. Hypervisor 210 may be configured to implement any suitable number of virtual machine nodes 208 on the computing device 200. The hypervisor 210 of FIG. 2 is shown has having instantiated three virtual machine nodes 208. Computing device 200 may be capable of supporting more virtual machine nodes as indicated by placeholder nodes 216. Hypervisor may be configured to instantiate any suitable number of virtual machine nodes 208 on computing device 200 depending on various factors, such as hardware configuration, software configuration, application, and the like.

As noted above, the volume of traffic and/or the number of requests received by a cloud computing system, such as cloud computing system 102 (FIG. 1), can vary widely over time for various reasons. The cloud computing system 102 includes an autoscaler 116 for adjusting the computing resources, e.g., number of virtual machine nodes 110 of servers 208, to respond to load variations in the cloud computing system 102. The autoscaler 116 is configured to monitor utilization of one or more nodes 110 or groups of nodes on one or more the servers 108 of the cloud computing system 102 and to scale up, e.g., provision additional nodes, or scale down, e.g., shut down nodes, as needed depending on the load on the system.

FIG. 3 shows an example implementation of an autoscaler 300 for autoscaling virtual machine nodes 310 of a at least one of server of a cloud computing system, such as cloud computing system 102. In the example of FIG. 3, virtual machine nodes 310 are hosted on two physical computing devices 302. In implementations, virtual machine nodes 310 may be hosted on more or fewer computing devices which are on the same server or spread across multiple servers. Computing devices 302 includes physical resources, such as CPU 304 and memory 306. Hypervisors (not shown) may be implemented on computing devices 302 for provisioning, shutting down, and otherwise managing virtual nodes 310.

In embodiments, virtual machine nodes of a cloud computing system, such as virtual nodes 310, may be allocated to one or more node groups with each node group being considered a single unit for autoscaling purposes. A node group may be comprised of virtual machine nodes that perform the same or similar operation(s) or function(s) for the server. Different node groups may be configured to perform different operations and/or functions in a server. Each node group may have a predefined default size, or number of instantiated nodes, that is selected to enable the group to maintain a desired level of utilization, and which may depend on the expected traffic to the group. A node group may also have predefined maximum and minimum sizes which define the maximum and minimum number of instantiated nodes, respectively, that may be in the group at any one time. In the example of FIG. 3, virtual machine nodes 310 are allocated to a node group 312. Node group 312 includes four instantiated nodes 310 and a number of potential nodes 311 (nodes that have not been instantiated), three of which are shown in FIG. 3. Node group 312 may have predefined parameters, such as a default size (e.g., four nodes), a maximum size (e.g., seven nodes), and a minimum size (e.g., one node).

Autoscaler 300 is configured to monitor the load on the virtual machine nodes 310 of node group 312 and to scale out the node group 312, e.g., by provisioning one or more additional nodes for the group, or scale in the node group, e.g., by shutting down one or more nodes from the node group, as needed to address variations in load on the system. To this end, autoscaler 300 includes a monitoring component 314 and an autoscaling component 316. Autoscaler also includes an overclocking component for overclocking CPUs of the computing devices 302 as node group 312 is being scaled out (explained in more detail below). In implementations, one or more of the monitoring component 314, autoscaling component 316, and overclocking component 318 may be implemented in one or more one or more computing devices and/or one or more virtual machine nodes, including the virtual machine nodes 310 or other nodes (not shown).

Monitoring component 314 is configured to monitor one or more metrics indicative of the load on virtual machine nodes 310. As examples, monitoring component 314 may be configured to monitor virtual processor utilization, physical processor utilization, numbers of connections (e.g., Transport Control Protocol (TCP) connections and/or Hypertext Transfer Protocol (HTTP) connections), and/or any other suitable metric indicative of the load on the node group. In embodiments, a metric may correspond to an average, mean, median, maximum, minimum, or some other statistical measure of the metric for the group.

Autoscaling component 316 is configured to implement an autoscaling process for scaling out or scaling in the node group 312 based on the one or more metrics monitored by monitoring component 314. The autoscaling component may be configured to implement the autoscaling process by causing the hypervisors of the computing devices 302 to provision a requisite number of nodes for the node group or shut down a requisite number of nodes for the node group, depending on the requirements of the autoscaling process.

In implementations, an autoscaling policy may be defined for a node group, such as node group 312, that defines rules for identifying when autoscaling is to be performed and for determining the autoscaling process to be performed. For example, an autoscaling policy for a node group may define one or more autoscaling conditions for indicating when autoscaling should be performed and an autoscaling process to be performed for each autoscaling condition. Examples of autoscaling conditions include processor utilization exceeding a predefined threshold and/or falling below a predefined threshold and number of connections exceeding a predefined threshold and/or falling below a predefined threshold.

An autoscaling process may be defined for each autoscaling condition that defines whether the node group should be scaled out or scaled in and the number of nodes to be provisioned or shut down for the node group. For example, an autoscaling process may be defined for when processor utilization exceeds a predefined threshold (e.g., 70%) that includes provisioning a predetermined number of nodes for the node group which may be any suitable number of nodes and may be specified in any suitable manner. As another example, an autoscaling process may be defined for when processor utilization falls below a predefined threshold (e.g., 30%) that includes shutting down a predetermined number of nodes for the node group. The number of nodes provisioned or shut down for an autoscaling process may be any suitable number of nodes and may be specified in any suitable manner, e.g., by selecting a particular number of nodes (e.g., 1, 2, 5, 10) and/or by specifying a percentage of nodes to provision or shut down for the node group.

As discussed above, provisioning additional virtual machine nodes to accommodate increases in load on the system may take a considerable amount of time as the virtual machine node(s) boot up and initialize before they become available to process requests. In the meantime, the increased load on the system may result in service slowdowns, dropped/rejected requests, or even outages while the additional nodes are initializing. To reduce the occurrence of delays and dropped/rejected requests, predictive autoscaling may be used to predict future loads on the system so that virtual machine nodes may be provisioned in advance of times when increased loads are predicted to occur. Predictions of future demands on the system may be based, at least in part, on historical data related to the metrics. The historical data may be used to identify trends and patterns that can be used to predict times when loads are likely to increase.

While predictive autoscaling may be useful in some cases, the predictions may not always be accurate and there may be instances when increased loads on the system are unexpected (e.g., unpredictable). In these situations, delays in service and dropped/rejected requests may still result as nodes are being provisioned to address increased loads on the system. To reduce and/or eliminate delays and/or dropped requests that may occur as virtual machine nodes are being provisioned, autoscaler 300 includes an overclocking component 318 configured to overclock the CPU 304 of at least one computing device 302 hosting the nodes 310 of the node group 312. When an autoscaling condition is detected that indicates an increased load on system that requires one or more nodes to be provisioned for the node group 312, the overclocking component 318 is configured to begin overclocking the CPU 304 of at least one computing device 302 by increasing the clock rates of the CPU 304 from a default clock rate to an overclocking rate for the CPU 304. Increasing the clock rate of the CPU 304 of a computing device hosting virtual machine nodes 310 enables the virtual machine nodes 310 to perform more operations per second so that requests may be processed at a faster rate than usual as nodes are being provisioned for the node group. In this way, delays and/or dropped requests that would otherwise result as nodes are being provisioned for the node group may be reduced and/or eliminated.

Overclocking component 318 may be configured to overclock a CPU in any suitable manner. For example, overclocking component 318 may be configured to manipulate the settings of a CPU, such as frequency, ratio/multiplier, and/or voltage, such that the clock rate of the CPU is increased from a normal, or default, clock rate to a predetermined overclock rate. Settings of the CPU 304 may be accessed via firmware (e.g., BIOS) of the computing device 302. The overclock rate may be any clock rate that results in increased processing speed for the virtual machine nodes without adversely impacting the performance and stability of the computing devices 302. A suitable overclock rate for the CPU 304 of a computing device 302 may be determined beforehand by testing the performance of the CPU with various settings.

After the autoscaling process has been completed and the one or more provisioned nodes 310 have been provisioned and are performing operations, overclocking component 318 is configured to return each overclocked CPU 304 to its default clock rate. In implementations, overclocking component 318 may be configured to return each overclocked CPU 304 to its default clock rate after a predetermined amount of time has passed which has been selected to allow for the completion of the autoscaling process. In other implementations, monitoring component 314 may be configured to detect when the autoscaling process has been completed and to notify overclocking component 318 to return each overclocked CPU to its default clock rate.

In implementations, an overclocking profile may be defined for each CPU 304 that includes the settings for overclocking the CPU 304. When a CPU 304 is to be overclocked, the overclocking component 318 may access the overclocking profile for the CPU to determine the settings for overclocking the CPU and then apply those settings to the CPU. In implementations, a default CPU profile may also be defined for each CPU that includes the settings for returning the clock rate of the CPU to its default clock rate. Overclocking profiles and default profiles may be stored in a memory of one or both of the computing devices 302, a memory of one or more of the virtual nodes 310, and/or any other memory which may be accessible by the overclocking component 318.

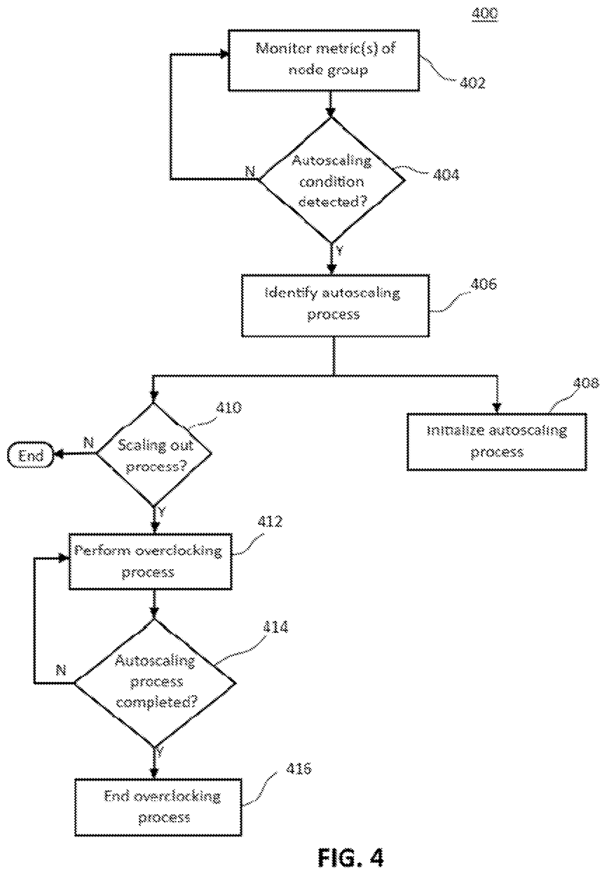

A method for autoscaling virtual machine nodes that utilizes overclocking is shown in FIG. 4. The method begins with monitoring one or more metrics pertaining to the virtual modes of a virtual node group (block 402). The one or more metrics may be any suitable metric capable of indicating the utilization or load on the nodes, and, in particular, variations in utilization or load on the nodes. Examples of suitable metrics include virtual processor utilization, physical processor utilization, TCP connections, and the like. The one or more metrics are monitored to detect one or more autoscaling conditions indicating that autoscaling is required for the nodes. Examples of autoscaling conditions that may be detected include processor utilization exceeding a predefine threshold, processor utilization falling below a predefined threshold, number of connections to the nodes exceeding a predefined threshold, number of connections falling below a predefined threshold, and the like. An autoscaling process may be defined for each autoscaling condition that defines whether the node group should be scaled out or scaled in and the number of nodes to be provisioned or shut down for the node group.

When an autoscaling condition is detected (block 404), the autoscaling process for the detected autoscaling condition is identified (block 406). When the detected autoscaling condition is related to an increase in load on the node group, the autoscaling process pertaining to the detected autoscaling condition may require that a predetermined number of nodes be provisioned for the node group. Conversely, when the detected autoscaling condition is related to a decrease in load on the node group, the autoscaling process pertaining to the detected autoscaling condition may require that a predetermined number of nodes be shut down for the node group. The determined autoscaling process is then initialized (block 408).

When the autoscaling process pertaining to the detected autoscaling condition is a scaling out process involving provisioning one or more additional nodes for the node group (block 410), an overclocking process is performed while the additional nodes are being provisioned for the node group (block 412). The overclocking process involves increasing the clock rate of one or more CPUs hosting the virtual nodes of the virtual node group a default clock rate to an overclock rate. The overclocking is maintained until the autoscaling process has been completed and the provisioned nodes are performing operations (block 414), at which point the overclocking process may be ended by returning the one or more overclocked CPUs to their default clock rates (block 416).

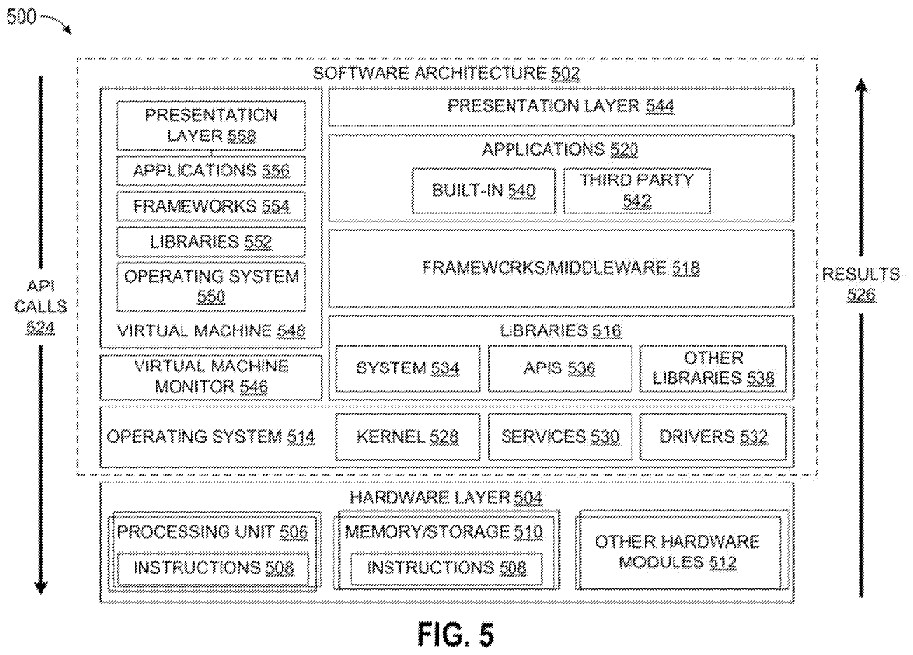

FIG. 5 is a block diagram 500 illustrating an example software architecture 502, various portions of which may be used in conjunction with various hardware architectures herein described, which may implement any of the above-described features. FIG. 5 is a non-limiting example of a software architecture and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

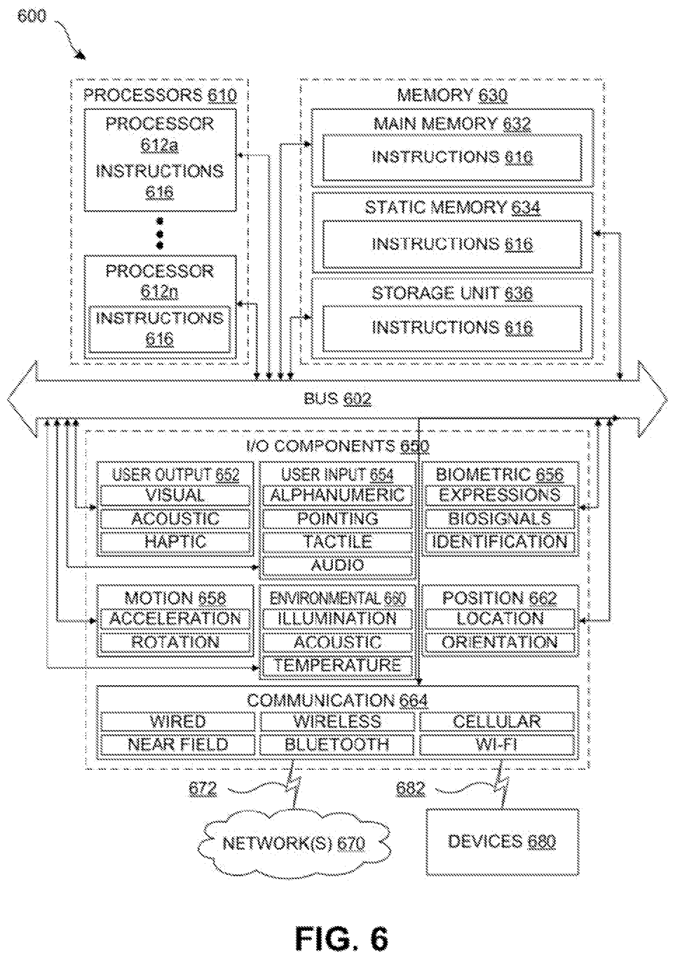

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 662, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A computing device comprising:
   a processor; and
   a memory in communication with the processor, the memory comprising executable instructions that, when executed by the processor, cause the computing device to perform functions of:
      monitoring one or more metrics of virtual machine nodes of a node group to detect an autoscaling condition requiring that one or more virtual machine nodes be provisioned or shut down for the node group;
      performing an autoscaling process associated with the autoscaling condition; and
      when the autoscaling process includes provisioning one or more additional nodes for the node group, performing an overclocking process to increase a clock rate of a processor of at least one computing device hosting the virtual machine nodes of the node group from a default clock rate to an overclocking rate, the overclocking process being performed while the one or more additional nodes are being provisioned.
Item 2. The computing device of item 1, further comprising:
   when the provisioning of the one or more additional nodes has completed, ending the overclocking process by returning the clock rate of the processor of the at least one computing device to the default clock rate.
Item 3. The computing device of any of items 1-2, wherein settings for the overclocking profile for a processor are determined by overclocking the processor before the processor is added to the server.
Item 4. The computing device of any of items 1-3, wherein an overclocking profile is stored in the memory, the overclocking profile defining overclock settings for increasing the clock rate of the processor from the default clock rate to the overclocking rate, and wherein the overclocking process includes accessing the overclocking profile in the memory to identify the overclock settings and then applying the overclock settings to the processor.
Item 5. The computing device of any of items 1-4, wherein a default clock profile is stored in the memory, the default clock profile defining default settings for returning the clock rate of the processor to the default clock rate, and wherein ending the overclocking process includes accessing the default clock profile in the memory to identify the default settings and then applying the default settings to the processor.
Item 6. The computing device of any of items 1-5, wherein one or more metrics includes a processor utilization of the virtual node machines.
Item 7. The computing device of any of items 1-6, wherein the one or more metrics includes a number of connections to the virtual machine nodes.
Item 8. The computing device of any of items 1-7, wherein the connections include Transport Control Protocol (TCP) connections.
Item 9. A method of autoscaling virtual machine nodes of a cloud computing system, the method comprising:
   monitoring one or more metrics of virtual machine nodes of a node group to detect an autoscaling condition requiring that one or more virtual machine nodes be provisioned or shut down for the node group;
   performing the autoscaling process associated with the autoscaling condition; and
   when an autoscaling process includes provisioning one or more additional nodes for the node group, performing an overclocking process to increase a clock rate of a processor of at least one computing device hosting the virtual machine nodes of the node group from a default clock rate to an overclocking rate, the overclocking process being performed while the one or more additional nodes are being provisioned.
Item 10. The method of item 9, further comprising:
   when the provisioning of the one or more additional nodes has completed, ending the overclocking process by returning the clock rate of the processor of the at least one computing device to the default clock rate.
Item 11. The method of any of items 9-10, wherein an overclocking profile is stored in a memory, the overclocking profile defining overclock settings for increasing the clock rate of the processor from the default clock rate to the overclocking rate, and wherein the overclocking process includes accessing the overclocking profile in the memory to identify the overclock settings and then applying the overclock settings to the processor.
Item 12. The method of any of items 9-11, wherein a default clock profile is stored in a memory, the default clock profile defining default settings for returning the clock rate of the processor to the default clock rate, and wherein ending the overclocking process includes accessing the default clock profile in the memory to identify the default settings and then applying the default settings to the processor.
Item 13. The method of any of items 9-12, wherein the one or more metrics includes a processor utilization of the virtual node machines.
Item 14. The method of any of items 9-13, wherein the one or more metrics includes a number of connections to the virtual machine nodes.
Item 15. A non-transitory computer readable medium on which are stored instructions that, when executed, cause a programmable device to perform functions of:
   monitoring one or more metrics of virtual machine nodes of a node group to detect an autoscaling condition requiring that one or more virtual machine nodes be provisioned or shut down for the node group;
   performing an autoscaling process associated with the autoscaling condition; and
   when the autoscaling process includes provisioning one or more additional nodes for the node group, performing an overclocking process to increase a clock rate of a processor of at least one computing device hosting the virtual machine nodes of the node group from a default clock rate to an overclocking rate, the overclocking process being performed while the one or more additional nodes are being provisioned.
Item 16. The non-transitory computer readable medium of item 15, wherein the functions further include:
   when the provisioning of the one or more additional nodes has completed, ending the overclocking process by returning the clock rate of the processor of the at least one computing device to the default clock rate.
Item 17. The non-transitory computer readable medium of any of items 15-16, wherein an overclocking profile is stored in a memory, the overclocking profile defining overclock settings for increasing the clock rate of the processor from the default clock rate to the overclocking rate, and wherein the overclocking process includes accessing the overclocking profile in the memory to identify the overclock settings and then applying the overclock settings to the processor.
Item 18. The non-transitory computer readable medium of any of items 15-17, wherein a default clock profile is stored in a memory, the default clock profile defining default settings for returning the clock rate of the processor to the default clock rate, and wherein ending the overclocking process includes accessing the default clock profile in the memory to identify the default settings and then applying the default settings to the processor.
Item 19. The non-transitory computer readable medium of any of items 15-18, wherein the one or more metrics includes a processor utilization of the virtual node machines.
Item 20. The non-transitory computer readable medium of any of items 15-19, wherein the one or more metrics includes a number of connections to the virtual machine nodes.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A computing device comprising:
a processor; and
a memory in communication with the processor, the memory comprising executable instructions that, when executed by the processor, cause the computing device to perform functions of:
monitoring one or more metrics of virtual machine nodes of a node group to detect an autoscaling condition requiring that one or more virtual machine nodes be provisioned or shut down for the node group;
performing an autoscaling process associated with the autoscaling condition; and
when the autoscaling process includes provisioning one or more additional nodes for the node group, performing an overclocking process to increase a clock rate of a processor of at least one computing device hosting the virtual machine nodes of the node group from a default clock rate to an overclocking rate, the overclocking process being performed while the one or more additional nodes are being provisioned.

2. The computing device of claim 1, further comprising:
when the provisioning of the one or more additional nodes has completed, ending the overclocking process by returning the clock rate of the processor of the at least one computing device to the default clock rate.

3. The computing device of claim 2, wherein settings for the overclocking profile for a processor are determined by overclocking the processor before the processor is added to the server.

4. The computing device of claim 2, wherein an overclocking profile is stored in the memory, the overclocking profile defining overclock settings for increasing the clock rate of the processor from the default clock rate to the overclocking rate, and wherein the overclocking process includes accessing the overclocking profile in the memory to identify the overclock settings and then applying the overclock settings to the processor.

5. The computing device of claim 2, wherein a default clock profile is stored in the memory, the default clock profile defining default settings for returning the clock rate of the processor to the default clock rate, and wherein ending the overclocking process includes accessing the default clock profile in the memory to identify the default settings and then applying the default settings to the processor.

6. The computing device of claim 1, wherein one or more metrics includes a processor utilization of the virtual node machines.

7. The computing device of claim 1, wherein the one or more metrics includes a number of connections to the virtual machine nodes.

8. The computing device of claim 1, wherein the connections include Transport Control Protocol (TCP) connections.

9. A method of autoscaling virtual machine nodes of a cloud computing system, the method comprising:
monitoring one or more metrics of virtual machine nodes of a node group to detect an autoscaling condition requiring that one or more virtual machine nodes be provisioned or shut down for the node group;
performing the autoscaling process associated with the autoscaling condition; and
when an autoscaling process includes provisioning one or more additional nodes for the node group, performing an overclocking process to increase a clock rate of a processor of at least one computing device hosting the virtual machine nodes of the node group from a default clock rate to an overclocking rate, the overclocking process being performed while the one or more additional nodes are being provisioned.

10. The method of claim 9, further comprising:
when the provisioning of the one or more additional nodes has completed, ending the overclocking process by returning the clock rate of the processor of the at least one computing device to the default clock rate.

11. The method of claim 10, wherein an overclocking profile is stored in a memory, the overclocking profile defining overclock settings for increasing the clock rate of the processor from the default clock rate to the overclocking rate, and wherein the overclocking process includes accessing the overclocking profile in the memory to identify the overclock settings and then applying the overclock settings to the processor.

12. The method of claim 10, wherein a default clock profile is stored in a memory, the default clock profile defining default settings for returning the clock rate of the processor to the default clock rate, and wherein ending the overclocking process includes accessing the default clock profile in the memory to identify the default settings and then applying the default settings to the processor.

13. The method of claim 9, wherein the one or more metrics includes a processor utilization of the virtual node machines.

14. The method of claim 9, wherein the one or more metrics includes a number of connections to the virtual machine nodes.

15. A non-transitory computer readable medium on which are stored instructions that, when executed, cause a programmable device to perform functions of:
monitoring one or more metrics of virtual machine nodes of a node group to detect an autoscaling condition requiring that one or more virtual machine nodes be provisioned or shut down for the node group;
performing an autoscaling process associated with the autoscaling condition; and
when the autoscaling process includes provisioning one or more additional nodes for the node group, performing an overclocking process to increase a clock rate of a processor of at least one computing device hosting the virtual machine nodes of the node group from a default clock rate to an overclocking rate, the overclocking process being performed while the one or more additional nodes are being provisioned.

16. The non-transitory computer readable medium of claim 15, wherein the functions further include:
when the provisioning of the one or more additional nodes has completed, ending the overclocking process by returning the clock rate of the processor of the at least one computing device to the default clock rate.

17. The non-transitory computer readable medium of claim 16, wherein an overclocking profile is stored in a memory, the overclocking profile defining overclock settings for increasing the clock rate of the processor from the default clock rate to the overclocking rate, and wherein the overclocking process includes accessing the overclocking profile in the memory to identify the overclock settings and then applying the overclock settings to the processor.

18. The non-transitory computer readable medium of claim 16, wherein a default clock profile is stored in a memory, the default clock profile defining default settings for returning the clock rate of the processor to the default clock rate, and wherein ending the overclocking process includes accessing the default clock profile in the memory to identify the default settings and then applying the default settings to the processor.

19. The non-transitory computer readable medium of claim 15, wherein the one or more metrics includes a processor utilization of the virtual node machines.

20. The non-transitory computer readable medium of claim 15, wherein the one or more metrics includes a number of connections to the virtual machine nodes.
